(19) United States
(12) Patent Application Publication
(10) Pub. No.: US 2026/0120983 A1
(43) Pub. Date: Apr. 30, 2026

(54) Electric Arc Interruption Arrangement

(71) Applicant: ABB Schweiz AG, Baden (CH)

(72) Inventors: James Mannekutla, Västerås (SE); Julia Viertel, Västerås (SE); Johan Nohlert, Västerås (SE); Thomas Eriksson, Bälinge (SE); Marley Becerra, Västerås (SE); Alessio Bergamini, Gazzaniga (IT)

(73) Assignee: ABB Schweiz AG, Baden (CH)

(21) Appl. No.: 19/371,018

(22) Filed: Oct. 28, 2025

(30) Foreign Application Priority Data
Oct. 29, 2024 (EP) 24209337

(51) Int. Cl. H01H 33/06

(52) U.S. Cl. CPC H01H 33/06

(57) ABSTRACT

An electric arc interruption arrangement comprising: a chamber having an inlet facing towards an arc zone, an electrically insulating and movable barrier arranged to move from a first position to a second position, wherein in the second position the electrically insulating and movable barrier splits the arc zone and is positioned at least partly in the chamber, a resiliently deformable seal arranged in a side wall in the chamber to contact and seal against the electrically insulating and movable barrier in its second position to interrupt an arc path between two electrical contacts.

### CROSS-REFERENCE TO RELATED APPLICATIONS

The instant application claims priority to European Patent Application No. 24209337.5, filed Oct. 29, 2024, which is incorporated herein in its entirety by reference.

### FIELD OF THE DISCLOSURE

The present disclosure generally relates to an electric arc interruption arrangement.

### BACKGROUND OF THE INVENTION

Electrical switching devices, such as circuit breakers and disconnect switches, are widely used in power distribution and electrical systems to control and interrupt electrical currents. These electrical switching devices are importantly able to interrupt fault currents and protect the electrical system from damage caused by overcurrent or short circuits.

During the interruption of high fault currents, an electric arc forms between the contacts of the electrical switching device. This arc can generate significant heat and damage the components of the switching device if not properly controlled or extinguished.

### BRIEF SUMMARY OF THE INVENTION

According to a first aspect, the present disclosure describes an electric arc interruption arrangement comprising: a chamber having an inlet facing towards an arc zone, an electrically insulating and movable barrier arranged to move from a first position to a second position, wherein in the second position the electrically insulating and movable barrier splits the arc zone and is positioned at least partly in the chamber, a resiliently deformable seal arranged in a side wall in the chamber to contact and seal against the electrically insulating and movable barrier in its second position to interrupt an arc path between two electrical contacts.

In one embodiment, a seal squeezes the arc against the insulating barrier to cut off the arc. Furthermore, the resilient deformable seal provides for compensating for the gap between the insulating barrier and the side wall in the chamber even in the event of minor erosion of the seal or insulating barrier due to natural material losses.

The resilient deformable seal provides for an efficient seal between the movable insulating barrier and the side wall of the chamber, even considering that the insulating barrier is movable relative to the side wall.

The arc zone is the area or volume or location where the arc is formed and from which the electrically insulation barrier pushes the arc into the chamber.

The seal may be arranged in an opening which may be a groove or trench that accommodates the seal. Part of the seal can protrude into the chamber such that it contacts the electrically insulation barrier when it moves in the chamber. The seal may equally well be stacked with side wall partitions that jointly form an outer side wall of the chamber

In one embodiment, the resiliently deformable seal comprises a base end supported in the side wall and a free end configured to protrude into the chamber. The free end is movable relative to the base end which is fixated in in the side wall of the chamber, for example in an opening of the side wall. The free end flexes into the chamber. This advantageously provides for an efficient seal that can account for erosion in the chamber and/or the electrically insulation barrier. That motion of the flexing may be in a radially inwards direction in a cylindrical geometry of the chamber.

In one embodiment, the resiliently deformable seal may comprise a gas pocket between the free end and the base end configured such that a gas pressure build-up in the gas pocket cause the free end to move into the chamber. When the movable electrically insulating barrier moves into and push the arc into the chamber and reaches the height where the seal is located, the free end of the seal partially blocks a gap on the side of the electrically insulating barrier. The pressure build-up in the gas pocket pushes the free end towards the electrically insulating barrier to close the gap. Advantageously, the seal take advantage of the pressure gradient in the chamber to seal against the electrically insulating barrier, providing for a self-activated seal.

In other words, the motion of the electrically insulating and movable barrier into the chamber advantageously causes the pressure build up in the gas pocket which consequently cause the seal to close the gap.

In one embodiment, the electric arc interruption arrangement may comprise: multiple resiliently deformable seals at different distances into the chamber from the inlet. In this way, a more efficient sealing is provided. The seals may be arranged in parallel at different distances into the chamber.

In one embodiment, the seal has a substantially U-shaped portion.

In one embodiment, the seal may comprise an inclined surface configured to engage with the electrically insulating barrier when it moves towards the second position. The inclined surface provides for more controlled force transfer between the seal and the electrically insulating barrier that reduces the risk of damaging the seal and instead pushing it towards the opening where it is fixated.

In one embodiment, the chamber and the barrier are tubular, and the seal is annular. This geometry facilitates sealing the chamber and cutting off the arc since no open edges are left where the arc can escape.

In one embodiment, an opening in the chamber may comprise an inner groove in which a fixing portion of the seal is mounted to fixate the seal. The inner groove is a smaller groove in the groove where the seal is located. The inner groove reduces the risk of the seal moving out of position due to the motion of the movable electrically insulating barrier.

The seal is preferable resilient meaning that it is configured to reshape to its initial shape when the barrier has moved back to its first position.

Preferably, the resiliently deformable seal is made from a polymeric material. The polymeric material is advantageously configured to withstand the heat generated during arc-quenching. That is, the material of the seal has arc-quenching functionality due to ablation. In some example embodiments, the polymeric material has temperature resistance levels of about 850° C. to about 950° C. and may comply with standard IEC 60695.

Different thermoplastic polymers may be considered as material for the seal. Those can be for example polyolefins, like PP or PE, fluorinated variants like PTFE or polyamides or polyacetals. The elastic moduli of the chosen polymer need to ensure deformation only in the elastic region.

In one embodiment, the electrically insulating and movable barrier may be configured with a tapered leading edge that gradually engages with the seal.

### BRIEF DESCRIPTION OF THE SEVERAL VIEWS OF THE DRAWING(S)

FIG. 1A is a schematic of an electric arc interruption arrangement in accordance with the disclosure.

FIG. 1B is a schematic of an electric arc interruption arrangement when the barrier has moved according to one embodiment of the present disclosure.

FIGS. 2A, 2B, and 2C are schematics of a sequence of arc quenching using an electric arc interruption arrangement according to the present disclosure.

FIG. 3 is a diagram of an electric arc interruption arrangement according to embodiments of the present disclosure.

### DETAILED DESCRIPTION OF THE INVENTION

In the present detailed description, various embodiments of the present invention are herein described with reference to specific implementations. In describing embodiments, specific terminology is employed for the sake of clarity. However, the invention is not intended to be limited to the specific terminology so selected. While specific exemplary embodiments are discussed, this is done for illustration purposes only. A person skilled in the relevant art will recognize that other components and configurations can be used without parting from the scope of the invention.

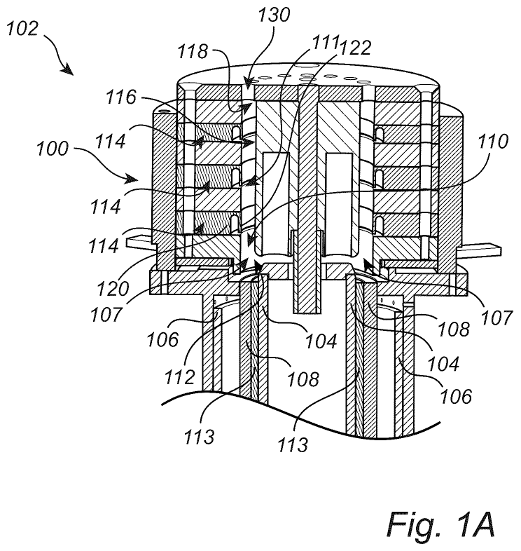

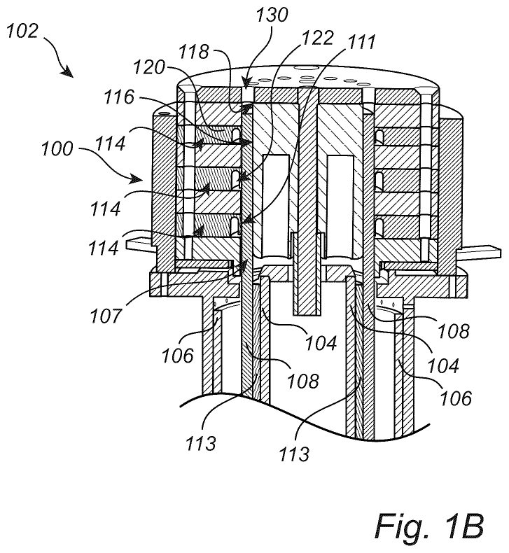

FIG. 1A schematically illustrates an electric arc interruption arrangement 100 according to embodiments. The electric arc interruption arrangement 100 is arranged as part of an electrical switch 102 configured for direct current applications.

The electrical switch 102 comprises a first electrode 104 and a second electrode 106 between which an electrical contact is controlled by the electric switch 102. The electrodes 104 and 106 may be Cu-electrodes. During an electric current interruption event between the first, inner, electrode 104 and the second, outer, electrode 106, an electric arc is formed between the electrodes 104, 106 in the arc zone 107. It is desirable to extinguish the arc to avoid or at least reduce erosion and damage to components of the electric switch. In example embodiments, the electrodes 104 and 106 are tubular and are arranged coaxially.

One way to quench the arc is by means of a mechanical constriction, here provided as the electrically insulating and movable barrier 108, also referred to as a movable barrier or a barrier herein. The barrier 108 is movable into a chamber 110 as it moves from a first position to a second position. In FIG. 1, the barrier 108 is in a first position outside the chamber 110. When the barrier 108 moves to a second position inside the chamber 110, the barrier 108 splits the arc zone 107, see FIG. 1B.

An insulating wall 113 separates the barrier 108 from the first electrode 104. That is, the insulating wall 113 is arranged between the barrier 108 and the first electrode 104.

To further enhance the mechanical constriction for the arc, a resiliently deformable seal 114 is arranged in a side wall 111 in the chamber 110 to contact and seal against the electrically insulating and movable barrier 108 in its second position. The seal 114 facilities in interrupting an arc path between two electrical contacts 104 and 106. In other words, when the barrier 108 is moved to inside the chamber 110, the resiliently deformable seal 114 ensures a tight fit to the barrier 108 in the chamber 110, even if some erosion and material loss has occurred over time, so that arc quenching is still accomplished.

The chamber 110 is constricted by the outer side wall 111, an inner side wall 116, and a top wall 118 that jointly close the chamber 110. The top wall 118 comprises gas outlets 130. The leading end of the barrier enters the chamber through the inlet 112 which may be closed by the barrier 108 when it is in the second position, shown in FIG. 1B.

The barrier 108 is made from a dielectric material such as plastic or polymer material. In this example embodiment, the barrier 108 and the chamber 110 are tubular. The tubular barrier 108 is movable to inside the tubular chamber 110. Furthermore, the seal 114 is annular and follows the shape of the outer wall 111 of the chamber 110. In this embodiment, multiple resiliently deformable seals 114 are arranged at different distances into the chamber 110 from the inlet 112.

The seal 114 comprises base end 120 supported in the side wall 111 and a free end 122 that is configured to protrude into the chamber 110. The free end 122 is moveable relative to the base end 120. That is, the free end 122 can flex into the chamber 110 to seal against the barrier 108. Generally, the seal 114 comprises a substantially U-shaped portion.

That the seal is resilient means that it is configured to reshape to its initial shape when the barrier 108 has moved back to its first position (FIG. 1A) from the second position (FIG. 1B) where it is in contact with the seal 114.

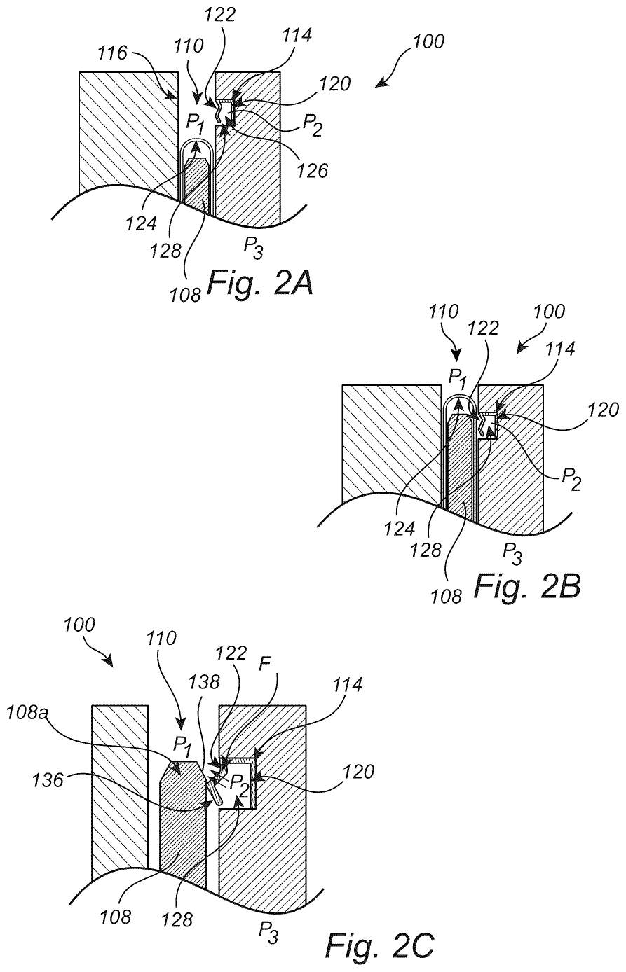

The resiliently deformable seal 114 is preferably made from a polymeric material. Advantageously, the polymeric material has is able to withstand the high temperature caused by the arc. FIG. 2A-C illustrates a sequence of arc quenching using an electric arc interruption arrangement 100 according to an embodiment. In FIG. 2A, the barrier 108 is in motion into the chamber 110 and consequently pushes the arc 124 into the chamber 110. The resiliently deformable seal 114 comprises a base end 120 supported in an opening 126 in the side wall 112 and a free end 122 that can protrude into the chamber 110. The opening 126 is a groove or trench in the side wall 111 that can accommodate the seal 114. The groove or trench 126 may be annular. The free end 122 can move or flex resiliently relative to the base end 120.

Furthermore, the resiliently deformable seal 114 comprises a gas pocket 128 between the free end 122 and the base 120 in the groove or trench 126.

In FIG. 2A, due to the presence of the arc 124, the pressure P3 by the contacts 102, 104 (see FIG. 1A-B) is relatively large such that there is a flow upwards towards a gas outlet 130 in the top wall 118. The pressure P2 within the gas pocket 128 of the seal 114 is nearly the same as the pressure P1 in the chamber 110 such that the free end 122, or seal lip 122, is in rest position.

FIG. 2B illustrates the barrier 108 when it has reached the location of the seal 114 in the chamber 110. The gas flow exiting the chamber 110 through the outlets 130 is locally reduced by the seal 114 free end 122 slightly protruding and reducing the gap through the chamber 110, i.e., between the barrier 108 and the side wall 112 constricted by the seal 114. That is, once the barrier 108 reaches the seal lip 122 height, the upward gas flow is hindered by the seal 114. As a consequence, the pressure P2 starts increasing above P1 such that a net radial force F is produced on the seal 114 free end 122. That is, the pressure inside the free end 122 is higher than the pressure in front of the seal free end 122. The radial force F plastically deforms the seal lip until the gap to the barrier 108 is entirely closed as illustrated in the close-up view in FIG. 2C, thereby completely squeezing the arc 124. In other words, the gas pressure build-up in the gas pocket 128 cause the free end 122 of the seal 114 to move into the chamber 110.

To improve the sealing capability and to facilitate for the barrier 108 to move past the seal, the seal comprises an inclined surface 136 configured to engage with the barrier 108 when it moves towards the second position. The inclined surface is located on the outermost portion of the free end 136 facing towards the inlet 112 of the chamber 110. In addition, the leading end 108a of the electrically insulating and movable barrier 108 is configured with a tapered leading edge 138 that gradually engages with the seal 114. The tapered leading edge 138 of the barrier 108 engages with the inclined surface 136 of the free end 122 of the seal 114. The inclined surface 136 is inclined with respect to the side wall 111 when the seal 114 is mounted in the side wall 111.

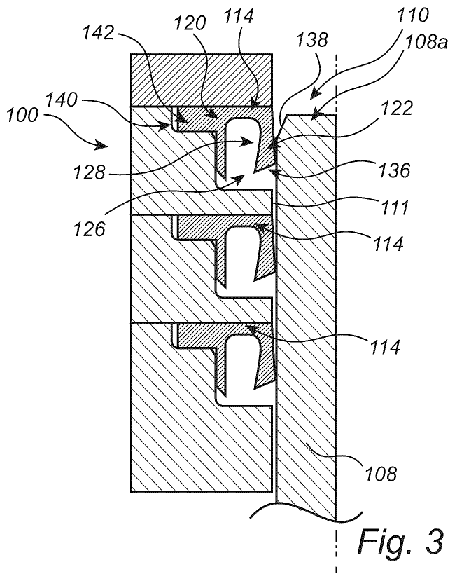

FIG. 3 is a cross-sectional view of a further embodiment of an electric arc interruption arrangement 100 where the annular seal 114 is arranged in an opening 126. The opening 126 may be an annular trench or groove in the side wall 111. Furthermore, opening 126 comprises an inner groove 140 in which a fixing portion 142 of the seal 114 is mounted to fixate the seal 114 in the side wall 111. Note again that multiple seals 114 are cascaded in the chamber 110.

The seal 114 shown in FIG. 3 is a U-shaped polymeric seal with a flanged heel 142 clamped in a groove 140 which prevents the seal(s) 114 from moving. The seal lip 122 closest to the barrier 108 is designed having a zero or low gap distance to the moving barrier 108 in its resting position. The gap should be smaller than the distance of a gap between the barrier 108 and the arc chamber side wall 111. In this way, there is no natural force against the tube causing static sealing. Thus, the mechanical friction of the seal(s) 114 against the barrier 108 is zero or low in the absence of the arc.

As an example, the thickness of the free end 122 may be about 1 mm and the displacement of the free end 122 caused by the pressure build up in the pocket 128 may be about 0.25 mm towards and into the chamber 110. The pressure difference P2-P1 may be about 1 bar.

An electrically insulating material may herein be a ceramic or a polymer, where the polymer may be a thermoset/rubber or thermoplastic polymer, such as polyoxymethylene (POM), poly(methyl methacrylate) (PMMA), polyimide (P1), polyamide (PA) and/or a polyolefin, such as polypropylene (PP) or poly-methyl-pentene (PMP) or another such polymer or high temperature resistant rubber material like silicone or fluorinated rubber, such as FKM or FFKM. Herein, for example the walls of the chamber and the barrier may be made from electrically insulating materials.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. An electric arc interruption arrangement (100) comprising:
a chamber having an inlet facing towards an arc zone;
an electrically insulating and movable barrier arranged to move from a first position to a second position, wherein in the second position the electrically insulating and movable barrier splits the arc zone and is positioned at least partly in the chamber;
a resiliently deformable seal arranged in a side wall in the chamber to contact and seal against the electrically insulating and movable barrier in its second position to interrupt an arc path between two electrical contacts.

2. The electric arc interruption arrangement according to claim 1, wherein the resiliently deformable seal comprises a base end supported in the side wall and a free end configured to protrude into the chamber.

3. The electric arc interruption arrangement according to claim 2, wherein the free end is movable relative the base end.

4. The electric arc interruption arrangement according to claim 2, wherein the resiliently deformable seal comprises a gas pocket disposed between the free end and the base end configured such that a gas pressure build up in the gas pocket cause the free end to move in the chamber.

5. The electric arc interruption arrangement according to claim 4, wherein the motion of the electrically insulating and movable barrier into the chamber causes the pressure build up in the gas pocket.

6. The electric arc interruption arrangement according to claim 1, further comprising multiple resiliently deformable seals at different distances into the chamber from the inlet.

7. The electric arc interruption arrangement according to claim 1, wherein the resiliently deformable seal has a substantially U-shaped portion.

8. The electric arc interruption arrangement according to claim 1, wherein the resiliently deformable seal comprises an inclined surface configured to engage with the barrier when it moves towards the second position.

9. The electric arc interruption arrangement according to claim 1, wherein the chamber and the barrier are tubular, and wherein the resiliently deformable seal is annular.

10. The electric arc interruption arrangement according to claim 1, wherein the resiliently deformable seal is arranged in an opening in the side wall of the chamber, the opening comprising an inner groove in which a fixing portion of the seal is mounted to fixate the seal.

11. The electric arc interruption arrangement according to claim 1, wherein the seal in configured to reshape to its initial shape when the barrier has moved back to its first position.

12. The electric arc interruption arrangement according to claim 1, wherein the resiliently deformable seal is made from a polymeric material.

13. The electric arc interruption arrangement according to claim 12, wherein the polymeric material has arc-quenching properties and is configured to withstand the temperature during arc-quenching.

14. The electric arc interruption arrangement according to claim 1, wherein the movable barrier is configured to push the arc into the chamber.

15. The electric arc interruption arrangement according to claim 1, wherein the electrically insulating and movable barrier is configured with a tapered leading edge that gradually engages with the resiliently deformable seal.
